(19) United States
(12) Patent Application Publication
(10) Pub. No.: US 2012/0098269 A1
(43) Pub. Date: Apr. 26, 2012

(54) GREASE COMPOSITION

(75) Inventor: Yukitoshi Fujinami, Chiba (JP)

(73) Assignee: IDEMITSU KOSAN CO., LTD., Tokyo (JP)

(21) Appl. No.: 13/380,063

(22) PCT Filed: Jun. 21, 2010
(86) PCT No.: PCT/JP2010/060438

§ 371 Date: Dec. 22, 2011

(30) Foreign Application Priority Data
Jun. 22, 2009 (JP) 2009-147619

(51) Int. Cl. F03D 9/00; F04D 29/04; C10M 169/06

(52) U.S. Cl. 290/55; 508/110; 508/152; 508/452; 415/229

(57) ABSTRACT

A grease composition includes a base oil and a thickener. The base oil includes a hydrocarbon-based synthetic oil at 40 mass % or more, and a component A at 20 mass % to 70 mass %, the component A having a kinematic viscosity of 70 mm²/s or less at 40 degrees C. A kinematic viscosity of the base oil is in a range from 200 mm²/s to 2000 mm²/s at 40 degrees C. A worked penetration of the grease composition is in a range from 220 to 350.

### TECHNICAL FIELD

The present invention relates to a grease composition. In particular, the present invention relates to a grease composition usable for a main bearing that receives a main shaft incorporated in a wind power generator and a pitch bearing that receives a blade shaft.

### BACKGROUND ART

A grease composition is used to lubricate a bearing that receives a large load, such as a main bearing that receives a main shaft incorporated in a wind power generator and a pitch bearing that receives a blade shaft. Such a main bearing and a pitch bearing are always subjected to fluctuations or slight vibrations due to a change in wind speed or slight control of the blade. In other words, a main bearing and a pitch bearing are in conditions that fretting wear thereof easily occurs. Since replacement of a malfunctioned bearing takes a lot of time and costs, what has been sought is a lubricant having an excellent fretting wear resistance and a long-lasting effect in the prevention of damage to a bearing.

For improving fretting wear resistance, there has been suggested a grease composition whose base oil is an ester synthetic oil having a kinematic viscosity of 200 to 2500 mm²/s at 100 degrees C. (see Patent Literature 1).

Additionally, for improving durability against a large load, it has been disclosed to use a high viscosity base oil for a grease composition and to blend an extreme pressure agent in the grease composition as needed (see Non-patent Literatures 1 and 2).

As a grease composition usable for a wind power generator, the following compositions have been suggested: a composition containing a base oil, a thickener, and oleoyl sarcosine (see Patent Literature 2); and a composition containing a base oil having a kinematic viscosity of 70 to 250 mm²/s at 40 degrees C., a thickener, and a carboxylic antirust additive (see Patent Literature 3).

### CITATION LIST

### Patent Literatures

| | |
|---|---|
| Patent Literature 1 | JP-A-2003-206939 |
| Patent Literature 2 | JP-A-2008-38088 |
| Patent Literature 3 | JP-A-2007-63423 |

### Non-Patent Literatures

Non-patent Literature 1 “Evaluation of Fretting Protection Property of Lubricating Grease Applied to Thrust Ball Bearing”, Tribologists, Vol. 54, No.1, (2009) 64

Non-patent Literature 2 “Fretting Wear Performance of Lithium 12-Hydroxystearate Greases for Thrust Ball Bearing in Reciprocating Motion”, Tribologists, Vol. 42, No. 6, (1997) 492

### SUMMARY OF THE INVENTION

### Problems to be Solved by the Invention

Main bearing and pitch bearing used in a wind power generator simultaneously require reduction in fretting wear due to rotation of main shaft and blade shaft and reduction in bearing wear due to the heavy weights of the main shaft and blade shaft received on the main bearing and pitch bearing, respectively. Even with the grease compositions disclosed in Patent Literatures 1 to 3 and Non-patent Literatures 1 and 2, such bearing wear and fretting wear are unlikely to be simultaneously suppressed. Additionally, using a high viscosity base oil leads to an increase in fretting wear.

An object of the invention is to provide a grease composition capable of simultaneously suppressing bearing wear caused under a high-load condition and fretting wear to provide a longer lifetime.

### Means for Solving the Problems

In order to solve the above problem, the following grease composition is provided according to an aspect of the invention.
[1] A grease composition including a base oil and a thickener, in which the base oil includes a hydrocarbon-based synthetic oil at 40 mass % or more, and a component A at 20 mass % to 70 mass %, the component A having a kinematic viscosity of 70 mm²/s or less at 40 degrees C., a kinematic viscosity of the base oil is in a range from 200 mm²/s to 2000 mm²/s at 40 degrees C., and a worked penetration of the grease composition is in a range from 220 to 350.
[2] In the grease composition, the thickener is a soap thickener.
[3] In the grease composition, the thickener is blended in the grease composition at 17 mass % or less of a total amount of the composition.
[4] In the grease composition, a sulfur-containing extreme pressure additive is blended in the grease composition at 0.01 mass % to 10 mass % of the total amount of the composition.
[5] In the grease composition, a petroleum resin is also blended in the base oil at 0.5 mass % to 30 mass % of the total amount of the composition.
[6] In the grease composition, the grease composition is used for at least one of a main bearing and a pitch bearing, the main bearing being connected to a main shaft to which a blade of a wind power generator is coupled, the pitch bearing being connected to a blade shaft incorporated in the blade.
[7] In the grease composition, the thickener is prepared by reacting a carboxylic acid with an alkali in the component A.

The grease composition according to the above aspect of the invention is capable of simultaneously suppressing bearing wear caused under a high-load condition and fretting wear to provide a longer lifetime, and thus is suitably usable for, in particular, a main bearing and a pitch bearing in a wind power generator.

### BRIEF DESCRIPTION OF DRAWING

FIG. 1 shows a wind power generator that uses a grease composition according to an exemplary embodiment of the invention.

### DESCRIPTION OF EXEMPLARY EMBODIMENT

An exemplary embodiment of the invention will be described below in detail.

A grease composition according to the exemplary embodiment (hereinafter also abbreviated as “grease”) includes a base oil and a thickener.

The base oil may be a hydrocarbon-based synthetic oil or a combination of hydrocarbon-based synthetic oil and mineral oil.

When the hydrocarbon-based synthetic oil is an aromatic oil, examples thereof include alkylbenzenes such as monoalkylbenzene and dialkylbenzene, and alkylnaphthalenes such as monoalkylnaphthalene, dialkylnaphthalene and polyalkylnaphthalene. When the hydrocarbon-based synthetic oil is an ester oil, examples thereof include diester oils such as dibutyl sebacate, di-2-ethylhexyl sebacate, dioctyl adipate, diisodecyl adipate, ditridecyl adipate, ditridecyl glutarate and methyl/acetyl ricinoleate, aromatic ester oils such as trioctyl trimellitate, tridecyl trimellitate and tetraoctyl pyromellitate, polyol ester oils such as trimethylol propane caprylate, trimethylol propane peralgonate, pentaerythritol-2-ethylhexanoate and pentaerythritol peralgonate, and complex ester oils (oligoesters of polyhydric alcohol and dibasic or monobasic mixed fatty acid). When the hydrocarbon-based synthetic oil is an ether oil, examples thereof include polyglycols such as polyethylene glycol, polypropylene glycol, polyethylene glycol monoether and polypropylene glycol monoether, phenyl ether oils such as monoalkyl triphenyl ether, alkyldiphenyl ether, dialkyldiphenyl ether, pentaphenyl ether, tetraphenyl ether, monoalkyl tetraphenyl ether and dialkyl tetraphenyl ether, olefin oligomers such as normal paraffin, isoparafin, polybutene, polyisobutylene, 1-decene oligomer, and co-oligomer of 1-decene and ethylene.

Usable mineral oils are ones that have been subjected to an appropriate combination of the following purification processes: vacuum distillation, oil deasphalting, solvent extraction, hydrocracking, solvent dewaxing, sulfate cleaning, clay purification, hydrorefining and the like.

The above hydrocarbon-based synthetic oils may be used singularly or in combination. The kinematic viscosity of the base oil is in a range from 200 mm²/s to 2000 mm²/s at 40 degrees C. When the kinematic viscosity is less than 200 mm²/s, fretting wear is reduced but bearing wear is increased, so that load bearing capacity is unlikely to be ensured. On the other hand, when the kinematic viscosity is more than 2000 mm²/s, fretting wear is likely to be increased. In view of the above, the kinematic viscosity at 40 degrees C. is preferably in a range from 300 mm²/s to 1500 mm²/s, more preferably in a range from 400 mm²/s to 750 mm²/s.

The blend ratio of the hydrocarbon-based synthetic oil in the base oil is 40 mass % or more. When the blend ratio of the hydrocarbon-based synthetic oil in the base oil is less than 40 mass %, it can be difficult to provide both high viscosity and low-temperature torque performance. In view of the above, the blend ratio of the hydrocarbon-based synthetic oil in the base oil is preferably 60 mass % or more, more preferably 70 mass % or more.

The base oil contains a component having a kinematic viscosity of 70 mm²/s or less at 40 degrees C. (component A). The blend ratio of the component A is in a range from 20 mass % to 70 mass %. When the kinematic viscosity of the component A in the base oil is small, a large amount of the base oil is likely to be evaporated during the production process. On the other hand, when the kinematic viscosity of the component A is more than 70 mm²/s, fretting wear is likely to be increased. In view of the above, the kinematic viscosity of the component A in the base oil at 40 degrees C. is preferably in a range from 10 mm²/s to 40 mm²/s, more preferably in a range from 20 mm²/s to 40 mm²/s.

When the blend ratio of the component A in the base oil is less than 20 mass %, fretting wear and pumpability are likely to be worsened. When the blend ratio of the component A is more than 70 mass %, the base oil is unlikely to be controlled to have high viscosity. In view of the above, the blend ratio of the component A in the base oil is preferably in a range from 30 mass % to 70% mass, more preferably in a range from 40 mass % to 65 mass %.

Examples of the component A in the base oil include olefin oligomers such as an oligomer of alpha-olefin having 4 to 18, preferably 6 to 14, more preferably 8 to 12 carbon atoms (either singular or combined) and a co-oligomer of 1-decene and ethylene. One of the above olefin oligomers may be used or, alternatively, a mixture thereof may be used. The above olefin oligomers may be composited in a known method or in a method as disclosed in any one of Japanese Patent Application No. 5-282511 (JP-A-07-133234) and Japanese Patent Application No. 1-269082 (JP-A-03-131612). The component A may be blended with a small amount of mineral oil without negatively affecting the low temperature properties.

Either an organic or inorganic thickener is usable as the thickener blended with the base oil, a preferred example of which is a soap thickener. Specifically, the thickener is preferably any one of Li soap, Li complex soap, Ca sulfonate complex soap and Ca complex soap, more preferably a soap containing a 12-hydroxystearate as a fatty acid. Among the above examples, the thickener is preferably a soap containing Li, more preferably a Li complex soap. A Li complex soap is excellent in performance balance from a low temperature to a high temperature.

As the thickener, urea compound, bentonite, silica, carbon black and the like may also be usable. The above materials may be used singularly or in combination.

The blend ratio of the thickener is not limited as long as the thickener and the base oil in combination can form a grease and be kept as the grease, but is preferably a 17 mass % or less of the total amount of the composition. When the blend ratio of the thickener is more than 17 mass % or more of the total amount of the composition, fretting wear is likely to be worsened. Additionally, the pumpability is also likely to be lowered. In view of the above, the blend ratio of the thickener relative to the total amount of the composition is more preferably 14 mass % or less, particularly preferably 12 mass % or less.

When the thickener is a soap thickener, the blend ratio of the thickener is represented as the amount of a carboxylic acid constituting the thickener. When the thickener is an urea thickener, the blend ratio of the thickener is represented as the amount of a reactant of isocyanate and amine.

The thickener is preferably produced by mixing carboxylic acid and alkali together in the component A of the base oil for saponification.

Examples of the carboxylic acid include wild fatty acids from which glycerin has been removed by hydrolyzing fat and oil, monocarboxylic acids such as a stearic acid, monohydroxy carboxylic acids such as a 12-hydroxy stearic acid, dibasic acids such as an azelaic acid, and aromatic carboxylic acids such as terephthalic acid, salicylic acid and benzoic acid. Carboxylates may also be usable. One of the above examples may be singularly used or, alternatively, two or more thereof may be used in combination.

Examples of the alkali include metal hydroxides such as alkali metals and alkali earth metals. Examples of the metal include sodium, calcium, lithium and aluminum.

In the grease, a sulfur-containing extreme pressure agent is preferably blended at 0.01 mass % to 10 mass % of the total amount of the composition. When the blend ratio is less than 0.01 mass % or more than 10 mass %, blend effect such as seizure prevention cannot be expected.

Examples of the extreme pressure agent include zinc dialkyldithiophosphate (ZnDTP), zinc dithiocarbamate (ZnDTC), dithiocarbamine (DTC), thiophosphate, sulfurized fat and oil, and thiadiazole. One of these compounds may be singularly used or, alternatively, two or more thereof may be used in combination.

The base oil may be blended with resins or waxes soluble in other base oils such as petroleum resin and polyethylene, among which a petroleum resin is preferable. The blend ratio of the resin is preferably in a range from 0.5 mass % to 30 mass % of the total amount of the composition. When the blend ratio of the resin relative to the total amount of the composition is less than 0.5 mass %, the viscosity is likely to be reduced. When the blend ratio of the resin is more than 30 mass %, the low-temperature torque performance is likely to be lowered. In view of the above, the blend ratio of the resin relative to the total amount of the composition is more preferably in a range from 1 mass % to 25% mass, particularly preferably in a range from 2 mass % to 20 mass %.

The petroleum resin is preferably, for instance, a cyclopentadiene-based petroleum resin. In other words, the petroleum resin is preferably provided by thermally copolymerizing a cyclopentadiene material with an alpha-olefin material or a monovinyl aromatic hydrocarbon material, by hydrogenating these materials in a general method as needed, or by mixing these materials.

Usable as the cyclopentadiene material are cyclopentadiene, the polymer thereof, the alkyl substitute thereof, and the mixture of these materials. From an industrial point of view, it is advantageous to use a cyclopentadiene fraction (CPD fraction) containing a cyclopentadiene material, which is obtained by steam cracking of naphtha or the like, at approximately 30 mass % or more, preferably at approximately 50 mass % or more. The CPD fraction may contain an olefin monomer copolymerizable with these alicyclic dienes. Examples of the olefin monomer include aliphatic diolefins such as isoprene, piperylene and butadiene, and alicyclic olefins such as cyclopentene. Although the concentration of the above olefins is preferably minimized, a concentration of approximately 10 mass % or less per cyclopentadiene material is acceptable.

Examples of the alpha-olefin material (a material copolymerizable with the cyclopentadiene material) include alpha-olefins having 4 to 18, preferably 4 to 12, carbon atoms, and the mixtures thereof, among which a derivative of ethylene, propylene, 1-butene or the like, a paraffin wax resolvent, or the like is preferably used. It is industrially preferable to blend the alpha-olefin material at a ratio of less than approximately 4 mol per 1 mol of the cyclopentadiene material.

Examples of the monovinyl aromatic hydrocarbons (the other material copolymerizable with the cyclopentadienes) include styrene, o-, m-, p-vinyltoluene, and alpha-, beta-methylstyrene. The monovinyl aromatic hydrocarbons may contain indenes such as indene methylindene, and ethylindene, and it is industrially advantageous to use a so-called C9 fraction obtained by steam cracking of naphtha. When the monovinyl aromatic hydrocarbons are used as a material to be copolymerized, it is industrially preferable to blend the monovinyl aromatic hydrocarbons at a ratio less than approximately 3 mol per 1 mol of the cyclopentadienes.

The worked penetration of the grease according to the exemplary embodiment is in a range from 220 to 350, preferably from 250 to 340, more preferably from 265 to 320. When the worked penetration is less than 220, the grease becomes harder, so that the low-temperature torque performance is likely to be lowered. When the worked penetration is more than 350, the grease becomes softer, so that shaft wear and fretting wear are likely to occur.

As long as an object of the invention is achieved, the grease according to the exemplary embodiment may be added with additives such as antioxidant, rust inhibitor, solid lubricant, filler, oiliness agent, metal deactivator, water resistant agent, extreme pressure agent, antiwear agent, viscosity index improver and coloring agent if necessary.

Examples of the antioxidant include aminic antioxidant such as alkylated diphenylamine, phenyl-alpha-naphthylamine and alkylated-alpha-naphthylamine, phenolic antioxidant such as 2,6-di-t-butyl-4-methylphenol and 4,4′-methylenebis(2,6-di-t-butylphenol), and peroxide decomposing agent of sulfur, ZnDTP or the like. The blend ratio thereof is usually in a range from 0.05 mass % to 10 mass %.

Examples of the rust inhibitor include sodium nitrite, sulfonate, sorbitan monooleate, fatty acid soap, amine compound, succinic acid derivative, thiadiazole, benzotriazole and benzotriazole derivative.

Examples of the solid lubricant include polyimide, PTFE, graphite, metal oxide, boron nitride, melamine cyanurate (MCA) and molybdenum disulfide. The above various additives may be blended singularly or in combination of some of them. The lubricant additive according to the invention is not intended to spoil such blend effect.

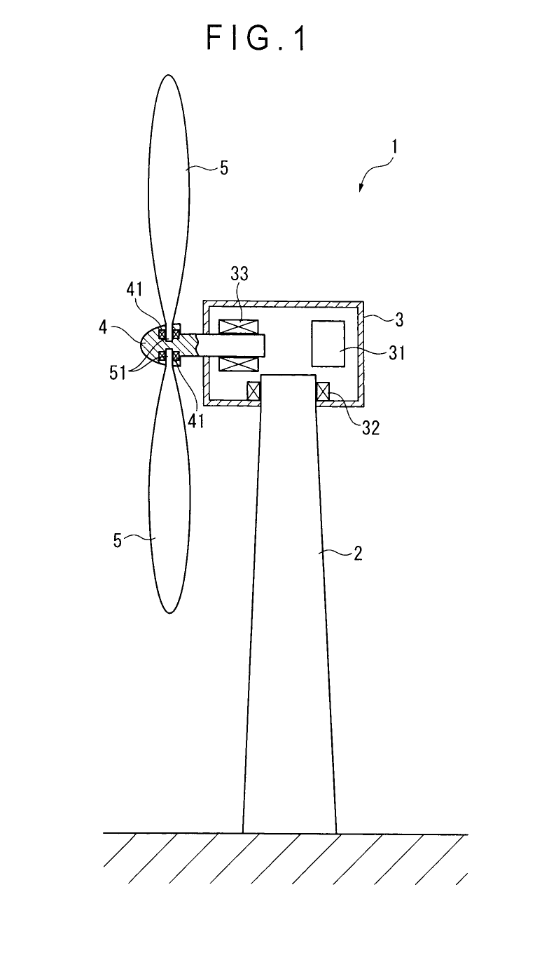

The grease composition having the above arrangement is favorably usable for a wind power generator 1. As shown in FIG. 1, the wind power generator 1 includes a blade 5, a main shaft 4 to which the blade 5 is fixed, an electricity generator 31 being driven by rotation of the main shaft 4, a nacelle 3 in which a main bearing 33 connected to the main shaft 4 and a yaw bearing 32 are housed, and a tower 2 that supports the nacelle 3. A pitch bearing 41 is connected to a blade shaft 51. For instance, by rotating the blade shaft 51, the blade 5 is controlled to receive more wind or less wind to stabilize the rotation of the main shaft 4. This results in stable supply of electricity from the electricity generator 31. The grease according to the exemplary embodiment is preferably used for the main bearing 33 and the pitch bearing 41. The main bearing 33 and the pitch bearing 41 are likely to suffer from shaft wear due to high loads such as the heavy blade 5 and main shaft 4 and fretting wear due to fluctuations or vibrations resulting from the rotation thereof. With the grease according to the exemplary embodiment, it is possible to prevent such shaft wear and fretting wear. Incidentally, if the wind power generator 1 is a small-sized wind power generator with an output less than 300 Kw, the invention is not suitably usable because of a small load thereon. The wind power generator 1 is preferably a middle-sized or large-sized wind power generator with an output of preferably 300 Kw or more, more preferably 700 Kw or more.

The main bearing 33 and the pitch bearing 41 may be connected to a pump for supplying grease thereto through a pipe (not shown). By driving the pump, it is possible to easily supply grease to the main bearing 33 and the pitch bearing 41. Working at height is thus not required, resulting in improvement of workability.

The grease having the above arrangement may be used for high load usage not only in a wind power generator but also in devices that perform rolling motion, such as rolling bearing, ball screw and linear guide. The grease is usable in, for instance, an electrical cylinder, an electrical linear actuator, a jack and a linear operating device.

### EXAMPLES

### Examples 1-12, Comparatives 1-3

### Production of Grease Composition

Grease compositions according to Examples and Comparatives were produced as follows. The composition ratio of each grease composition is shown in Tables 1 to 3. Table 4 shows the properties of each material shown in Tables 1 to 3.

### Examples 1-10 and 12

(1) PAO-A, 12-hydroxy stearic acid, azelaic acid and rust inhibitor (the respective amounts thereof are shown in Tables 1 and 2) were heated to 95 degrees C. while being stirred in a reaction vessel.
(2) Lithium hydroxide (monohydrate) was dissolved in 5 parts water (mass ratio). The resulting aqueous solution and the solution of (1) were blended together and heated to be mixed. After being heated to 195 degrees C., the temperature of the mixture was maintained for five minutes. In Examples 8 and 9, after being heated to 170 degrees C., the temperature of the mixture was maintained for five minutes. In Example 10, after being heated to 185 degrees C., the temperature of the mixture was maintained for five minutes.
(3) After being blended with the rest of the base oil, the mixture was cooled down to 80 degrees C. at a pace of 50 degrees C. per hour, and then antioxidant and extreme pressure agent (the respective amounts thereof are shown in Tables 1 and 2) were added thereto.
(4) After being naturally cooled down to room temperature, the mixture was subjected to a finishing process using a three-roller device. In this manner, each of the grease compositions according to Examples 1 to 10 and 12 was obtained.

### Example 11

(1) 1 mol of diphenylmethane-4,4′-diisocyanate (MDI) was dissolved in ⅔ of mass of PAO-A while being heated, thereby providing Material 1.
(2) 2 mol of cyclohexylamine was dissolved in the rest of PAO-A while being stirred, thereby providing Material 2.
(3) Material 1 was intensely stirred in a grease reaction vessel at 50 to 60 degrees C. and, simultaneously, Material 2 was gradually poured therein.

The mixture was stirred while being heated. After being heated to 165 degrees C., the temperature of the resulting grease composition was maintained for one hour.
(4) After being blended with the rest of the base oil, the mixture was cooled down to 80 degrees C. at a pace of 50 degrees C. per hour, and then antioxidant and extreme pressure agent (the respective amounts thereof are shown in Table 2) were blended therewith. After being naturally cooled down to room temperature, the mixture was subjected to a finishing process using a three-roller device to obtain the grease composition according to Example 11.

### Comparatives 1 and 2

(1) A part of PAO-B (50 mass % relative to the amount of the resulting grease) and 12-hydroxy stearic acid, azelaic acid and rust inhibitor (the respective amounts thereof are shown in Table 3) were heated to 95 degrees C. while being stirred in a reaction vessel.
(2) Lithium hydroxide (monohydrate) was dissolved in 5 parts water (mass ratio). The resulting aqueous solution and the solution of (1) were blended together and heated to be mixed. After being heated to 195 degrees C., the temperature of the mixture was maintained for five minutes.
(3) After being blended with the rest of the base oil, the mixture was cooled down to 80 degrees C. at a pace of 50 degrees C. per hour, and then antioxidant and extreme pressure agent (the respective amounts thereof are shown in Table 3) were added thereto.
(4) After being naturally cooled down to room temperature, the mixture was subjected to a finishing process using a three-roller device. In this manner, each of the grease compositions according to Comparatives 1 and 2 was obtained.

### Comparative 3

(1) A part of PAO-A (50 mass % relative to the amount of the resulting grease) and 12-hydroxy stearic acid, azelaic acid and rust inhibitor (the respective amounts thereof are shown in Table 3) were heated to 95 degrees C. while being stirred in a reaction vessel.
(2) Lithium hydroxide (monohydrate) was dissolved in 5 parts water (mass ratio). The resulting aqueous solution and the solution of (1) were blended together and heated to be mixed. After being heated to 195 degrees C., the temperature of the mixture was maintained for five minutes.
(3) After being blended with the rest of the base oil, the mixture was cooled down to 80 degrees C. at a pace of 50 degrees C. per hour, and then antioxidant and extreme pressure agent (the respective amounts thereof are shown in Table 3) were added thereto.
(4) After being naturally cooled down to room temperature, the mixture was subjected to a finishing process using a three-roller device to obtain the grease composition according to Comparative 3.

Incidentally, when the content of an olefin oligomer is more than 70 mass %, it is necessary to add a low-viscosity oil with a slight amount of a polymer base oil to increase the viscosity thereof, which complicates viscosity control.

TABLE 1

| | | | | Example 1 | Example 2 | Example 3 | Example 4 | Example 5 | Example 6 |
|---|---|---|---|---|---|---|---|---|---|
| Composition | Base | Hydrocarbon-based | PAO-A | 51.25 | 52.36 | 54.21 | 56.10 | 30.00 | 58.02 |
| Ratio | Oil | Synthetic Oil | PAO-B | — | — | — | — | — | — |
| (mass %) | | | PAO-C | — | — | — | — | 52.30 | — |
| | | | Olefin Oligomer | 17.74 | 18.12 | 18.77 | 19.42 | — | 24.28 |
| | | Other Base Oil | Petroleum Resin | 9.86 | 10.07 | 10.43 | 10.79 | — | — |

| | | | | | | | |
|---|---|---|---|---|---|---|---|
| Thickener | 12-Hydroxy Stearic Acid | 9.00 | 7.50 | 5.00 | 2.50 | 6.00 | 6.00 |
| | Azelaic Acid | 4.00 | 4.00 | 4.00 | 4.00 | 4.00 | 4.00 |
| | Lithium hydroxide (Monohydrate) | 3.15 | 2.95 | 2.60 | 2.20 | 2.70 | 2.70 |
| | Thickener Blend Ratio | 13.00 | 11.50 | 9.00 | 6.50 | 10.00 | 10.00 |
| | (Carboxylic Acid Amount | | | | | | |
| | Equivalent) | | | | | | |
| Additive | Antioxidant | 1.00 | 1.00 | 1.00 | 1.00 | 1.00 | 1.00 |
| | Rust Inhibitor | 1.00 | 1.00 | 1.00 | 1.00 | 1.00 | 1.00 |
| | Extreme Pressure Agent | 3.00 | 3.00 | 3.00 | 3.00 | 3.00 | 3.00 |

| | | | | | | | |
|---|---|---|---|---|---|---|---|
| | Total | 100.00 | 100.00 | 100.00 | 100.00 | 100.00 | 100.00 |
| Properties of | Kinematic Viscosity of Base Oil (40° C.) (mm²/s) | 460 | 460 | 460 | 460 | 460 | 460 |
| Grease | Worked Penetration 25° C., mixed 60 times | 250 | 271 | 293 | 323 | 290 | 305 |
| Composition | Dropping Point (° C.) | 273 | 290 or | 290 or | 290 or | 285 | 290 or |
| | | | more | more | more | | more |
| Evaluation | Fretting Wear Test (ASTM D4170 method) (mg) | 17.0 | 7.4 | 2.5 | 1.7 | 3.2 | 2.6 |
| Results | Low-temperature Torque Test (−40° C.) (mN · m) | 680/250 | 620/200 | 490/150 | 420/130 | 480/110 | 370/90 |
| | High-load Shaft Bearing Wear Test | | | | | | |
| | Rolling Element Wear Amount m_{w50} (mg) | — | — | 7 | — | — | — |
| | Bearing Ring Wear Amount m₅₀ (mg) | — | — | 5 | — | — | — |
| | Retainer Wear Amount mₖ₅₀ (mg) | — | — | 28 | — | — | — |
| | Grease Pumpability | — | — | 24.9 | — | — | — |
| | Pump Discharge Pressure (MPa) | | | | | | |
| | Oil Separation after Pressurization (IP121 method) 40° C., | 0.2 | 0.9 | 1.1 | 1.6 | 1.1 | 1.3 |
| | 42 h (mass %) | | | | | | |

TABLE 2

| | | | | | | | Example | Example | Example |
|---|---|---|---|---|---|---|---|---|---|
| | | | | Example 7 | Example 8 | Example 9 | 10 | 11 | 12 |
| Composition | Base | Hydrocarbon-based | PAO-A | 54.21 | 50.90 | 47.78 | 48.57 | 52.65 | 65.00 |
| Ratio | Oil | Synthetic Oil | PAO-B | — | — | — | — | — | — |
| (mass %) | | | PAO-C | — | — | — | — | — | — |
| | | | Olefin Oligomer | 18.77 | 21.30 | 16.54 | — | 18.23 | 18.40 |
| | | Other Base Oil | Petroleum Resin | 10.43 | — | 9.19 | 34.83 | 10.13 | — |

| | | | | | | | |
|---|---|---|---|---|---|---|---|
| Thickener | 12-Hydroxy Stearic Acid | 5.00 | 13.50 | 13.00 | 5.00 | urea | 5.00 |
| | Azelaic Acid | 4.00 | 5.00 | 4.50 | 4.00 | 14% | 4.00 |
| | Lithium hydroxide (Monohydrate) | 2.60 | 4.30 | 4.00 | 2.60 | | 2.60 |
| | Thickener Blend Ratio | 9.00 | 18.50 | 17.50 | 9.00 | 14.00 | 9.00 |
| | (Carboxylic Acid Amount | | | | | | |
| | Equivalent) | | | | | | |
| Additive | Antioxidant | 1.00 | 1.00 | 1.00 | 1.00 | 1.00 | 1.00 |
| | Rust Inhibitor | 1.00 | 1.00 | 1.00 | 1.00 | 1.00 | 1.00 |
| | Extreme Pressure Agent | 3.00 | 3.00 | 3.00 | 3.00 | 3.00 | 3.00 |

| | | | | | | | |
|---|---|---|---|---|---|---|---|
| | Total | 100.00 | 100.00 | 100.00 | 100.00 | 100.00 | 100.00 |
| Properties of | Kinematic Viscosity of Base Oil (40° C.) (mm²/s) | 220 | 460 | 460 | 460 | 460 | 260 |
| Grease | Worked Penetration 25° C., mixed 60 times | 293 | 318 | 280 | 283 | 293 | 285 |
| Composition | Dropping Point (° C.) | 290 or | 243 | 264 | 290 or | 290 or | 289 |
| | | more | | | more | more | |
| Evaluation | Fretting Wear Test (ASTM D4170 method) (mg) | 2.3 | 24.0 | 26.8 | 2.4 | 6.5 | 3.3 |
| Results | Low-temperature Torque Test (−40° C.) (mN · m) | 320/100 | 540/230 | 790/370 | 2900/2600 | 580/210 | 500/160 |
| | High-load Shaft Bearing Wear Test | | | | | | |
| | Rolling Element Wear Amount m_{w50} (mg) | 14 | — | — | — | 42 | 6 |
| | Bearing Ring Wear Amount m₅₀ (mg) | 15 | — | — | — | 26 | 9 |
| | Retainer Wear Amount mₖ₅₀ (mg) | 53 | — | — | — | 105 | 25 |
| | Grease Pumpability | 22.6 | — | — | — | 26.9 | 24.5 |
| | Pump Discharge Pressure (MPa) | | | | | | |
| | Oil Separation after Pressurization (IP121 method) 40° C., | 1.9 | 1.1 | 1.0 | 0.7 | 0.8 | 1.1 |
| | 42 h (mass %) | | | | | | |

TABLE 3

| | | | | Comparative 1 | Comparative 2 | Comparative 3 |
|---|---|---|---|---|---|---|
| Composition | Base | Hydrocarbon-based | PAO-A | — | 13.28 | 83.40 |
| Ratio | Oil | Synthetic Oil | PAO-B | 69.86 | 58.92 | — |
| (mass %) | | | PAO-C | — | — | — |
| | | | Olefin Oligomer | 1.79 | — | — |
| | | Other Base Oil | Petroleum Resin | — | — | — |

| | | | | |
|---|---|---|---|---|
| Thickener | 12-Hydroxy Stearic Acid | 14.00 | 13.50 | 5.00 |
| | Azelaic Acid | 5.00 | 5.00 | 4.00 |
| | Lithium hydroxide (Monohydrate) | 4.35 | 4.30 | 2.60 |
| | Thickener Blend Ratio | 19.00 | 18.50 | 9.00 |
| | (Carboxylic Acid Amount Equivalent) | | | |
| Additive | Antioxidant | 1.00 | 1.00 | 1.00 |
| | Rust Inhibitor | 1.00 | 1.00 | 1.00 |
| | Extreme Pressure Agent | 3.00 | 3.00 | 3.00 |

| | | | | |
|---|---|---|---|---|
| | Total | 100.00 | 100.00 | 100.00 |
| Properties of | Kinematic Viscosity of Base Oil (40° C.) (mm²/s) | 460 | 220 | 30 |
| Grease | Worked Penetration 25° C., mixed 60 times | 294 | 288 | 290 |
| Composition | Dropping Point (° C.) | 265 | 266 | 290 or more |
| Evaluation | Fretting Wear Test (ASTM D4170 method) (mg) | 43.6 | 34.3 | 1.9 |
| Results | Low-temperature Torque Test (−40° C.) (mN · m) | 1460/1200 | 420/220 | 130/38 |
| | High-load Shaft Bearing Wear Test | | | |
| | Rolling Element Wear Amount m_{w50} (mg) | 20 | — | 56 |
| | Bearing Ring Wear Amount m₅₀ (mg) | 27 | — | 46 |
| | Retainer Wear Amount mₖ₅₀ (mg) | 65 | — | 166 |
| | Grease Pumpability | 29.6 | 31.0 | — |
| | Pump Discharge Pressure (MPa) | | | |
| | Oil Separation after Pressurization (IP121 method) 40° C., | 1.2 | 2.0 | 16.3 |
| | 42 h (mass %) | | | |

TABLE 4

| | |
|---|---|
| Antioxidant | p,p′-dioctyldiphenylamine |
| Rust Inhibitor | calcium sulfonate |
| Extreme | zinc diamyldithiocarbamate |
| Pressure Agent | |
| PAO-A | polyalpha-olefin, kinematic viscosity (40° C.): 30.1 |
| | mm²/s, kinematic viscosity (100° C.): 5.78 mm²/s |
| PAO-B | polyalpha-olefin, kinematic viscosity (40° C.): 402 |
| | mm²/s, kinematic viscosity (100° C.): 40.6 mm²/s |
| PAO-C | polyalpha-olefin, kinematic viscosity (40° C.): 3100 |
| | mm²/s, kinematic viscosity (100° C.): 300 mm²/s |
| Olefin Oligomer | LUCANT HC-2000 (product name: manufactured by |
| | Mitsui Chemicals, Inc.) |
| Petroleum Resin | dicyclopentadiene/aromatic copolymer-based |
| | hydrogenated petroleum resin softening point 100° C., |
| | average molecular weight: 660, density (20° C.): 1.03 |
| | g/cm³, bromine number: 2.5 g/100 g |

In Tables 1 to 3, the blend ratio of the thickener has been defined as the amount of the carboxylic acid (12-hydroxy stearic acid+azelaic acid).

### Evaluation Method

The properties and wear resistance of each of the grease compositions according to above Examples and Comparatives were evaluated. Specific evaluation conditions were as follows.
(1) Worked Penetration: Measurement was made in a method according to JIS K 2220.7 (25 degrees C., 60W).
(2) Dropping Point: Measurement was made in a method according to JIS K 2220.8.
(3) Fretting Wear Test: Measurement was made in a method according to ASTM D4170. The composition was set in a laboratory whose temperature was controlled to (22±2 degrees C.). The temperature of the laboratory was not controlled after the test was started.
(4) Low-temperature Torque Test: Measurement was made in a method according to JIS K 2220.18. The temperature was set at −40 degrees C. for the measurement.
(5) High-load Shaft Bearing Wear Test: Measurement was made in a method according to DIN51819-2.
(Test Conditions: DIN51819-2-C-75/50-120, Load: 50 KN, Temperature: 120 degrees C., Rotation Speed: 75 rpm) The respective weights of bearing ring (inner ring+outer ring), rolling element (assembly of 16 rollers) and retainer were measured before and after the test, and a weight reduction for each bearing was calculated as a value of 50% probability of wear according to DIN51819-2.11.
(6) Oil Separation after Pressurization: Measurement was made in a method according to IP121 (40 degrees C., 42 h).
(7) Grease Pumpability: Evaluation was made in terms of a discharge pressure at the time when grease was pushed out using an automatic grease-supplying pump. A manometer (for discharge pressure measurement) and a 4mm inner diameter pipe (10 m) were connected in this sequence to a grease outlet of the automatic grease-supplying pump (manufactured by LINCOLN INDUSTRIAL CORPORATION, Quicklub Pump model 203), and a distributor was also used to divide it into two systems. A pipe of 4 mm inner diameter×4 m length was connected to each system. The grease was discharged through this pipe and a relief valve (12 MPa). The pump and pipes were filled with the grease in a room whose temperature was controlled to 20 to 25 degrees C., and the pump was driven for two hours after the discharge pressure thereof was stabilized. An average discharge pressure (MPa) during the two-hour driving was measured. A grease requiring a smaller discharge pressure is superior in pumpability because such a grease can be pushed out with a smaller pressure.

### Evaluation Results

As is apparent from the results shown in Tables 1 to 3, it has been found that the grease compositions according to Examples 1 to 12 are excellent in bearing wear properties and fretting wear properties. Additionally, it has been found that, in particular, the grease compositions according to Examples 3 and 7 are excellent also in low-temperature torque performance, and thus are suitably usable for a wind power generator or the like installed outside. On the other hand, according to Comparative 1, the blend ratio of the component A in the base oil was less than 20 mass %, which resulted in lowered fretting wear properties and pumpability and increased low-temperature torque. According to Comparative 2, the component A was not blended, which resulted in lowered fretting wear properties and pumpability. According to Comparative 3, bearing wear was increased to reduce oil separation.

### INDUSTRIAL APPLICABILITY

The invention is suitable as a grease composition usable for a main bearing and a pitch bearing incorporated in a wind power generator or the like.

### EXPLANATION OF CODES

1 . . . wind power generator, 2 . . . tower, 3 . . . nacelle, 4 . . . main shaft, 5 . . . blade, 31 . . . electricity generator, 32 . . . yaw bearing, 33 . . . main bearing, 41 . . . pitch bearing, 51 . . . blade shaft

1. A grease composition, comprising:
a base oil; and
a thickener,
wherein the base oil comprises a hydrocarbon-based synthetic oil at 40 mass % or more and a component A at from 20 mass % to 70 mass %,
a kinematic viscosity of the component A is 70 mm²/s or less at 40 degrees C.,
a kinematic viscosity of the base oil is from 200 mm²/s to 2000 mm²/s at 40 degrees C., and
a worked penetration of the grease composition is from 220 to 350.

2. The composition of claim 1, wherein the thickener is a soap thickener.

3. The composition of claim 1,
wherein the thickener is 17 mass % or less of a total amount of the composition.

4. The composition of claim 1, further comprising:
an extreme pressure additive comprising sulfur, at from 0.01 mass % to 10 mass % of a total amount of the composition.

5. The composition of claim 1, further comprising:
a petroleum resin in the base oil at from 0.5 mass % to 30 mass % of a total amount of the composition.

6. (canceled)

7. The composition of claim 1,
wherein the thickener is obtained by reacting a carboxylic acid with an alkali in the component A.

8. A wind power generator, comprising:
a main bearing, lubricated by the composition of claim 1;
a main shaft connected to the main bearing; and
a blade coupled to the shaft.

9. A wind power generator, comprising:
a pitch bearing, lubricated by the composition of claim 1, and
a blade, comprising a blade shaft connected to the pitch bearing.

10. The wind power generator of claim 8, further comprising:
a pitch bearing, lubricated by the composition of claim 1, and
a blade, comprising a blade shaft connected to the pitch bearing.

11. The composition of claim 1, wherein the hydrocarbon-based synthetic oil comprises the component A.

12. The composition of claim 1, wherein the kinematic viscosity of the base oil is from 300 mm²/s to 1500 mm²/s at 40 degrees C.

13. The composition of claim 12, wherein the kinematic viscosity of the base oil is from 400 mm²/s to 750 mm²/s at 40 degrees C.

14. The composition of claim 1, wherein the hydrocarbon-based synthetic oil is at least 60 mass % of the base oil.

15. The composition of claim 14, wherein the hydrocarbon-based synthetic oil is at least 70 mass % of the base oil.

16. The composition of claim 1, wherein the component A comprises an olefin oligomer, a co-oligomer of 1-decene and ethylene, or a mixture thereof.

17. The composition of claim 16, wherein the component A comprises an olefin oligomer, comprising an oligomer of alpha-olefin, comprising from 4 to 18 carbon atoms.

18. The composition of claim 1, wherein the kinematic viscosity of the component A is from 10 mm²/s to 40 mm²/s at 40 degrees C.

19. The composition of claim 18, wherein the kinematic viscosity of the component A is from 20 mm²/s to 40 mm²/s at 40 degrees C.

20. The wind power generator of claim 8, wherein the generator is capable of producing an output of 300 kW or more.

21. The wind power generator of claim 9, wherein the generator is capable of producing an output of 300 kW or more.
